(19) United States
(12) Patent Application Publication
(10) Pub. No.: US 2014/0077407 A1
(43) Pub. Date: Mar. 20, 2014

(54) METHOD AND DEVICE FOR PRODUCING SLABSTOCK FOAM

(71) Applicant: Jutta Huland, Wermelskirchen (DE)

(72) Inventors: Klaus-Werner Huland, Wermelskirchen (DE); Sascha Fahlenkamp, Koln (DE); Joachim Tykfer, Leverkusen (DE); Erwin Otto, Leverkusen (DE); Roger Scholz, Doenrade (NL)

(73) Assignee: Bayer MaterialScience AG, Leverkusen (DE)

(21) Appl. No.: 12/865,019

(22) PCT Filed: Jan. 29, 2009
(86) PCT No.: PCT/EP09/00554

§ 371 Date: Nov. 5, 2010

(30) Foreign Application Priority Data
Jan. 31, 2008 (DE) 10 2008 007 078.5

(51) Int. Cl. B29C 44/02

(52) U.S. Cl. CPC B29C 44/025
USPC 264/54; 249/117

(57) ABSTRACT

The present invention concerns a method for the production of slabstock foam, wherein a vessel which is open on its underside is placed onto the bottom of a foaming box, the vessel is filled with reaction components and subsequently removed. In the utilized vessel its horizontal cross-sectional contour can be described by, starting from a basic body which comprises at least three corners, a protrusion (3) is provided in the area of at least one of the corners. The invention further concerns a device for the discontinuous production of slabstock foam, comprising a foaming box and lid (11) to be placed into the foaming box. The lid (11) comprises an opening (12) which matches the contour of a vessel whose horizontal cross-sectional contour can be described by, starting from a basic body which comprises at least three corners, a protrusion (3) is provided in the area of at least one of the corners. The vessel may be characterized as a “golden bucket”.

The present invention concerns a method and a device for the production of slabstock foam, wherein a vessel which is open on its underside is placed onto the bottom of a foaming box, the vessel is filled with foam forming reaction components and subsequently removed.

In the discontinuous process for the production of slabstock foam, for example for the production of polyurethane foam, usually a reaction mixture is applied to the bottom of a container. The reaction mixture foams, expands during the foaming and occupies the volume provided by the container. The container is frequently referred to as a foaming box and the process as discontinuous box foaming.

When the reaction mixture is prepared in a mixing head immediately prior to the production of the slabstock foam and applied to the bottom of the container, a certain amount of time lapses between the beginning and the end of the application. During this time the reaction mixture already flows over the bottom of the container and reacts under formation of foam. As a result zones of differing ages and differing reaction progress are present in the finished product. However, this variation of properties, for example the variation of foam density, is undesired for the further processing of the resulting slabstock foam.

In order to apply a more homogenous reaction mixture to the bottom of the foaming box it has been suggested to prepare the reaction mixture in a bottomless vessel, to mix it and to remove this vessel. This procedure is also known as the “golden bucket”.

In this respect, DE 29 01 177 A1 discloses an apparatus for the discontinuous production of slabstock foam, wherein a mixing means, comprising component feed lines and a stirrer, is provided movably in a perpendicular fashion in a bridge-like frame. As a mixing vessel the mixing means features a bottomless cylinder barrel which is located at a head plate and which can be positioned on the bottom of a foam box to be placed beneath the mixing means. In these apparatuses the bottomless cylinder barrel serving as a mixing chamber is lowered to the bottom of the foaming box prior to the application of the reaction components. After finishing the mixing, the mixing means with the bottomless cylinder barrel is lifted upwards. The mixed reaction components then flow over the bottom of the foaming box.

U.S. Pat. No. 2,649,620 discloses a method for the production of slabstock foam, comprising the placing of a continuous, rigid and upright standing side wall on the bottom of a molding pan in order to confine a relatively small area therefrom and to thus form a mixing vessel which can be disassembled. Here also the formed mixing vessel is filled with a reaction mixture and subsequently removed upwards. The mixing vessel as a whole has a cylindrical form.

In the described cylindrical forms of the mixing vessel the reaction mixture spreads radially over the bottom of the foaming box after the vessel has been lifted. In general, the mixing vessel is placed in the center of the foaming box. If the foaming box itself does not have a circular cross-section, but rather the rectangular cross-section as common in production, the wave front of the reaction mixture will first reach the long side of the foaming box. This is the side with the shortest distance to the center of the bottom. Afterwards, the wave front reaches the short sides and lastly the corners of the foaming box. When the wave front meets the side walls the reaction mixture can only expand upwards. This leads to layering effects and to the compression of the material near the sides by the foaming reaction mixture further to the interior. Because the wave fronts of the reaction mixture reach the sides of the foaming box at different times, ultimately inhomogenities in the final foam body will manifest themselves. These appear especially in the form of density variations.

Due to the viscosity of the reaction mixture, the temperature and the foam development after the onset of the reaction, further fluid dynamic phenomena can be observed during the flow of the mixture. If a wave front reaches the side of the foaming box prematurely, it is partially reflected. The reflected waves superpose with other waves in the spreading reaction mixture. The flow of the reaction mixture itself from the mixing vessel also creates waves. In summary, inhomogenities in the finished foam body may also be present due to undesired wave superpositions.

From the preceding it is apparent that there is still the need for a method for the production of slabstock foam where lower variations in the density of the resulting foam body are present. The present invention therefore has the object of providing such an improved process and a device suitable for this.

According to the invention this object is met by a method for the production of slabstock foam, wherein a vessel which is open on its underside is placed onto the bottom of a foaming box, the vessel is filled with reaction components and subsequently removed and wherein furthermore in the utilized vessel its horizontal cross-sectional contour can be described by, starting from a basic body which comprises at least three corners, a protrusion is provided in the area of at least one of the corners. By this shaping it is achieved that the fluid front with the reaction mixture spreading after the removal of the vessel continuously adapts to the geometry of the foaming box and thus reaches the walls and corners of the foaming box at the same time or with less time delay than in a conventionally shaped vessel. This results in more homogenous product properties, especially a more uniform density distribution, in the foam body after the end of the foaming reaction. The vessel may also be completely or partially open on its upper side in order to receive the reaction mixture.

The shape of the vessel and especially the contour of the open underside is most appropriately described by considering the horizontal cross-section of the vessel. Hence a description of the vessel is reduced to a description of the contour of this cross-section. The contour then indicates the position of the vessel wall. The contour itself may be described as a combination or merging of a basic body with form elements representing protrusions from the interior of the vessel.

The protrusion may, for instance, take the shape of a circular arc, an elliptical arc or a parabolic arc. The protrusion is provided at the corners of the basic body. This means that the protrusion is located in the area of the corner and therefore the corner merges into the protrusion.

In an embodiment of the method according to the invention the basic body comprises four corners, adjacent corners are connected by concave lines and a protrusion is provided at all of the four corners. Therefore the basic body may be described as a quadrangle whose sides are not straight, but rather bent towards the interior of the quadrangle. The corners of this quadrangle then merge into the protrusions, meaning that they are encircled by the protrusions. The joining of the exterior contours of the deformed quadrangle and the protrusions then results in the horizontal cross-section of the vessel.

In another embodiment of the method according to the invention the basic body comprises four corners, adjacent corners are connected by convex lines and a protrusion is provided at all of the four corners. Therefore the basic body may be described as a quadrangle whose sides are not straight, but rather bent away from the interior of the quadrangle. The corners of this quadrangle then merge into the protrusions, meaning that they are encircled by the protrusions. The joining of the exterior contours of the deformed quadrangle and the protrusions then results in the horizontal cross-section of the vessel.

In another embodiment of the method according to the invention the basic body comprises four corners, adjacent corners are connected by straight lines and a protrusion is provided at all of the four corners. Therefore the basic body may be described as a quadrangle whose sides are straight. Opposing sides may be parallel and adjacent sides may be orthogonally arranged towards each other. As a result, for example, a parallelogram, a rectangle or a square may be obtained. The corners of this quadrangle then merge into the protrusions, meaning that they are encircled by the protrusions. The joining of the exterior contours of the quadrangle and the protrusions then results in the horizontal cross-section of the vessel.

If the basic body is a rectangle, the long side of the basic body and the long side of the foaming box may have a length ratio of ≧1:2 to ≦1:5. The length ratio may also be in a range of ≧1:2.5 to ≦1:4 or of ≧1:3 to ≦1:3.5.

If the basic body is a rectangle, furthermore the short side of the basic body and the short side of the foaming box may have a length ratio of ≧1:2 to ≦1:5. The length ratio may also be in a range of ≧1:2.5 to ≦1:4 or of ≧1:3 to ≦1:3.5.

If the basic body is a rectangle, the protrusions may be part of a circular arc and the distance of the center of the underlying circle to the corresponding corner of the rectangle on the one hand and the underlying radius of the circular arc on the other hand may have a length ratio of ≧1:10 to ≦1:1. Ultimately, this describes the distance of the circular arc protrusion from the corner of the rectangle which is used as an intermediary construction clement. If the stated length ratio is, for example; 1:10, then this means that the center of the underlying circle is has been moved by a distance of 10% of its radius from the corner. The range of the length ratios may also be from ≧1:50 to ≦1:1 or from ≧1:10 to ≦1:40.

If the basic body is a rectangle and the protrusions are part of a circular arc, the underlying radius of the circular arc and a side of the rectangular basic body may have a length ratio of ≧1:1 to ≦1:10, of ≧1:2 to ≦1:8 or of ≧1:4 to ≦1:6. This describes the proportion of the total contour of the cross-section that the protrusion occupies.

In a further embodiment of the method according to the invention the slabstock foam is polyurethane foam and the reaction components comprise a polyol component and an isocyanate component. The reaction components may either be pre-mixed and introduced into the vessel or the polyol component and the isocyanate component may be provided separately into the vessel and then mixed, for example with a stirring apparatus.

Another aspect of the present invention is a device for the discontinuous production of slabstock foam, comprising a foaming box and lid to be placed into the foaming box. The lid comprises an opening which matches the contour of a vessel. The horizontal cross-sectional contour of the vessel can be described by, starting from a basic body which comprises at least three corners, a protrusion is provided in the area of at least one of the corners. According to the invention it is envisioned that the lid is supported on the bottom of the foaming box by its sidewalls so that a cavity is formed under the lid. This cavity may be filled with a reaction mixture using the vessel according to the invention. The reaction mixture spreads evenly throughout the bottom of the foaming box, foams and then presses the lid upwards in the further course of the foam development.

The opening in the lid, meaning in the horizontal lid surface, is adapted for receiving a vessel which can have the previously described geometries. The device is especially suited for the production of polyurethane foam.

The present invention is further described with reference to the following drawings, wherein

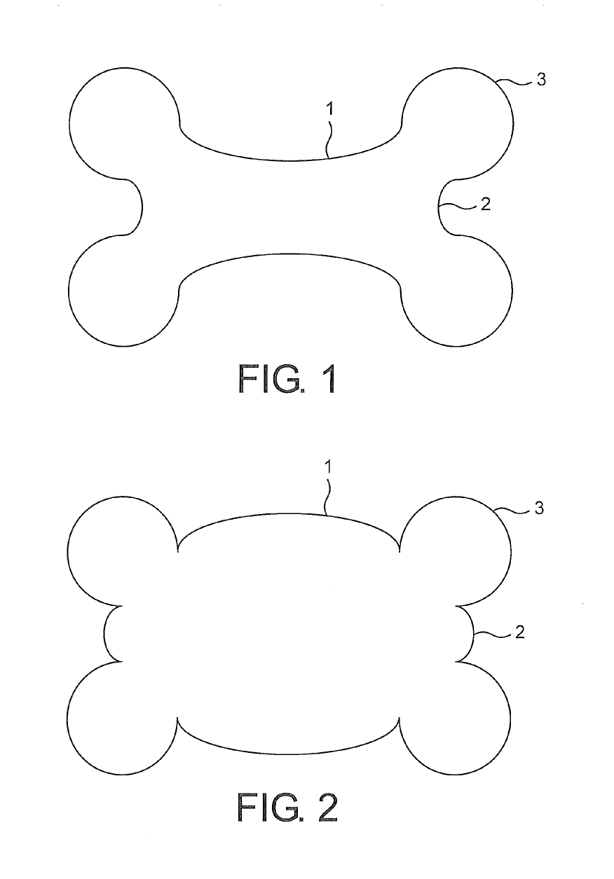

FIG. 1 shows the horizontal cross-sectional contour of a vessel for the method according to the invention

FIG. 2 shows the horizontal cross-sectional contour of another vessel for the method according to the invention

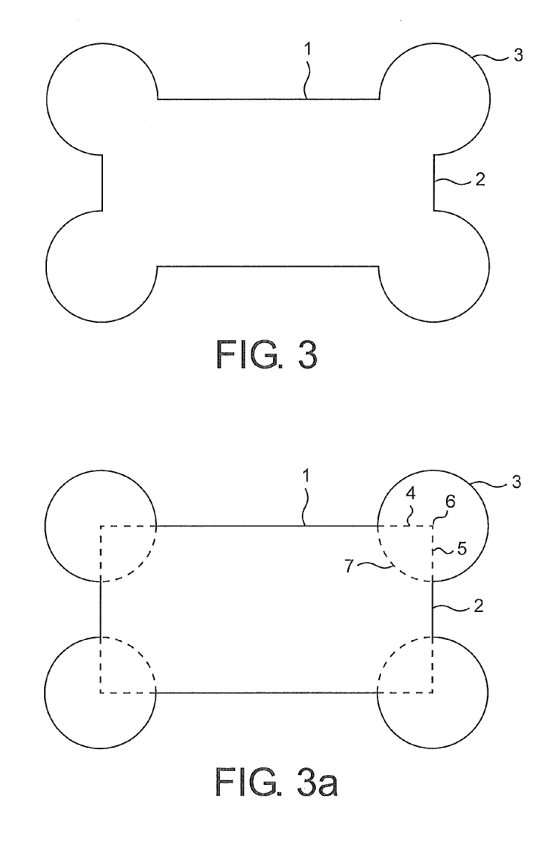

FIG. 3 shows the horizontal cross-sectional contour of another vessel for the method according to the invention

FIG. 3a shows the geometric construction of the cross-sectional contour of the vessel from FIG. 3

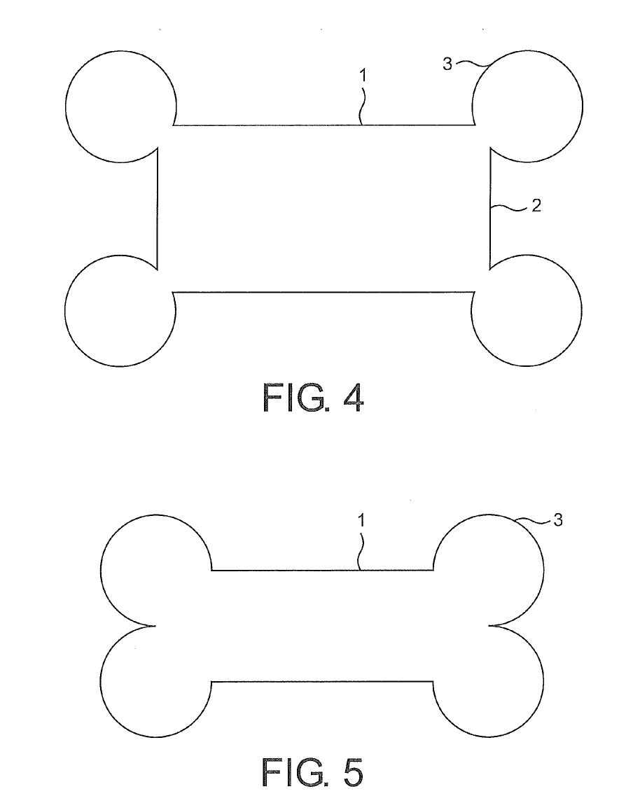

FIG. 4 shows a further variation of a cross-sectional contour from FIG. 3

FIG. 5 shows a further variation of a cross-sectional contour from FIG. 3

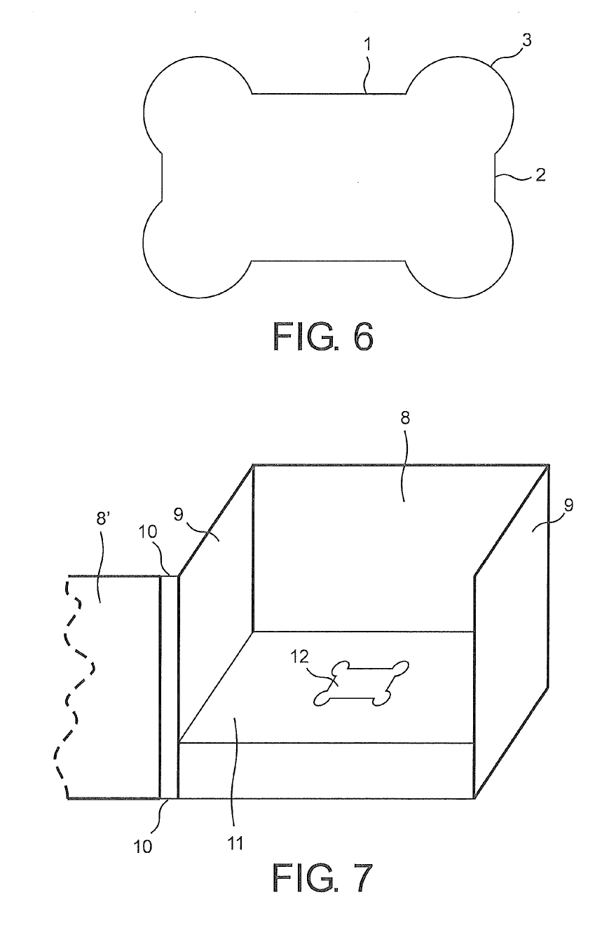

FIG. 6 shows a further variation of a cross-sectional contour from FIG. 3

FIG. 7 shows a foaming box for the production of slabstock foam

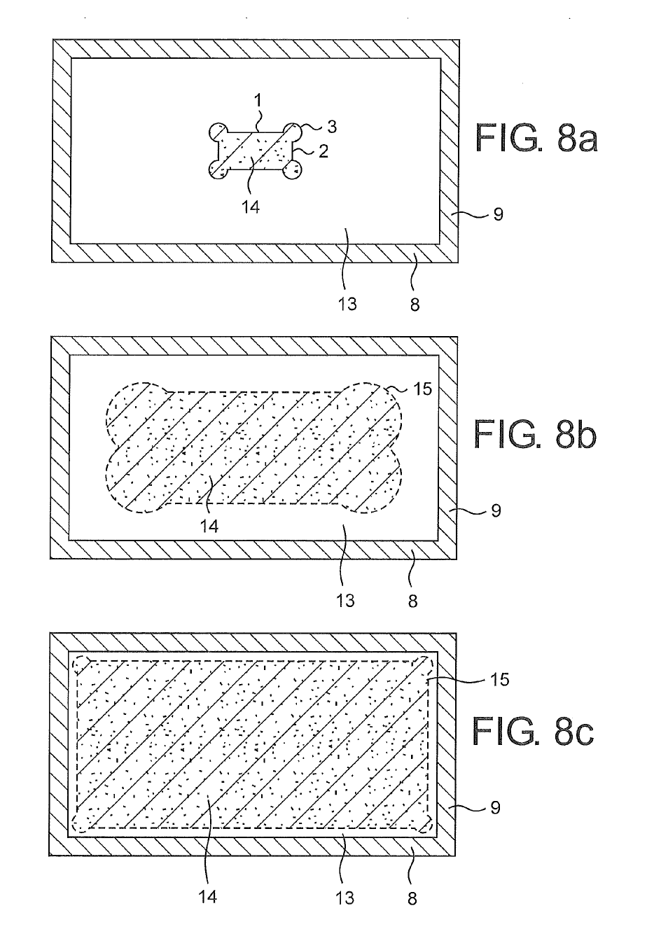

FIG. 8a-8c show the chronological sequence of charging a foaming box

FIG. 1 shows the horizontal cross-sectional contour of a vessel which is used in the method according to the invention. As a whole the vessel has an elongate cross-sectional shape with a long side 1 and a short side 2. At the edges of the contour there are curved protrusions 3 which may be seen as parts of a circular arc. In the present contour the contours of the long side 1 and the short side 2 are both concave, meaning curved towards the interior of the vessel.

FIG. 2 shows the horizontal cross-sectional contour of a further vessel which is used in the method according to the invention. As a whole the vessel has an elongate cross-sectional shape with a long side 1 and a short side 2. At the edges of the contour there are curved protrusions 3 which may be seen as parts of a circular arc. In the present contour the contours of the long side 1 and the short side 2 are both convex, meaning curved away from the interior of the vessel.

FIG. 3 shows the horizontal cross-sectional contour of a further vessel which is used in the method according to the invention. As a whole the vessel has an elongate shape with a long side 1 and a short side 2. At the edges of the contour there are curved protrusions 3 which may be seen as parts of a circular arc. In the present contour the contours of the long side 1 and the short side 2 are both linear. These linear sections 1 and 2 of the contour and hence of the vessel wall can be understood as the remains of a rectangular basic body. If sections 1 and 2 are extended until they intersect, the rectangular basic body is obtained geometrically. The curved protrusions 3 may likewise be understood as parts of a circular arc.

For better understanding, FIG. 3a shows the geometric construction of the contour or vessel side wall shown in FIG. 3. The rectangular basic body is formed by the wall sections 1, 2, 4 and 5. The corners are depicted by points 6. At the same time, the corners 6 are the centers for circles formed by circular arcs 3 and 7. Upon combining the circles and the rectangular basic body the dashed segments are removed and the cross-sectional contour according to FIG. 3 remains.

FIG. 4 shows a further variation of a horizontal cross-section of a vessel for a method according to the invention. As opposed to FIG. 3, the centers of the circles which form the circular are protrusions 3 are positioned outside the rectangular basic body with the wall sections 1 and 2.

FIG. 5 shows a further variation of a horizontal cross-section of a vessel for a method according to the invention. As in FIG. 3, the centers of the circles forming the circular arc protrusions 3 are positioned on the corners of the rectangular basic body. However, the diameter of the circles is exactly as large as the shorter side of the rectangle, so that the wall section 2 of FIG. 3 cannot be seen any more.

FIG. 6 shows a further variation of a horizontal cross-section of a vessel for a method according to the invention. As opposed to FIG. 3 the centers of the circles which form the circular arc protrusions 3 are positioned inside the rectangular basic body with the wall sections 1 and 2.

FIG. 7 shows a foaming box for the production of slabstock foam. The foaming box comprises the walls 8 and 9. The fourth side wall, 8′, which is indicated in the drawing, has been opened to the side via joints 10. Into the foaming box the lid 11 has been placed. The lid 11 is supported by its side walls on the bottom of the foaming box so that a cavity is created under the lid 11. This cavity can be charged with a foam forming reaction mixture. The lid 11 also has an opening 12 which is adapted to receive a vessel. The horizontal cross-section of the opening and hence of the corresponding vessel is defined by a rectangular basic body which further features curved protrusions at the corners. It is advantageous that the opening 12 of the lid 11 corresponds to the form of the vessel because then a better scaling of the lid against the reaction mixture can be achieved.

FIG. 8a-8c show schematically how the bottom of a foaming box is charged with a reaction mixture in the method according to the invention. The viewer's perspective is directly from above onto the foaming box. FIG. 8a shows the initial situation. The foaming box is defined by the long sides 8, the short sides 9 and the bottom 13. In the center of the foaming box a vessel is positioned which has a rectangular basic body, as defined by wall sections 1 and 2, and curved protrusions 3. The vessel is filled with a foam forming reaction mixture 14.

In FIG. 8b the vessel, which is open on its underside, has been removed. Accordingly the reaction mixture 14 flows over the bottom 13 of the foaming box. Due to the shape of the vessel the reaction mixture 14 does not spread in a radial, even way. Rather, it starts with the original vessel shape. During the course of the reaction mixture 14 spreading, its form corresponds more and more to the shape of the foaming box. The propagating wave front 15 is shown with a broken line.

FIG. 8c shows a situation further on in time after the removal of the vessel. The reaction mixture 14 now nearly completely covers the bottom 13 of the foaming box. It can be seen that the distance of the wave front 15 to the long sides 8 and the short sides 9 as well as to the corners of the foaming box only shows slight differences. The wave front 15 will reach the walls 8, 9 and the corners of the container essentially at the same time.

The present invention has been described as belonging to a method for the production of slabstock foam. It is also within the scope of the invention and its equivalents that the method with the vessel as described according to the invention may be used wherever it is important to distribute a fluid, especially a viscous and/or a reacting fluid, over an area in such a way that the fluid reaches the corresponding vertical area limitations with as little a time difference as possible.

### LIST OF REFERENCE NUMERALS

1 Side of the cross-sectional contour
2 Side of the cross-sectional contour
3 Protrusion
4 Linear wall section of the cross-sectional contour
5 Linear wall section of the cross-sectional contour
6 Corner of the rectangular basic body
7 Circular arc
8 Side of the foaming box
9 Side of the foaming box
10 Joint
11 Lid
12 Opening
13 Bottom of the foaming box
14 Reaction mixture
15 Wave front

1.-10. (canceled)

11. A method for the production of slabstock foam, the method comprising:
placing a vessel which is open on its underside onto a bottom of a foaming box, wherein the vessel has a horizontal cross-sectional contour comprising at least three corners, with a protrusion extending from at least one of the corners;
filling the vessel with reaction components; and
subsequently removing the vessel from the foaming box.

12. The method according to claim 11, wherein the horizontal cross-sectional contour comprises four corners, with a protrusion extending from each corner and adjacent corners being connected by concave lines.

13. The method according to claim 11, wherein the horizontal cross-sectional contour comprises four corners, with a protrusion extending from each corner and adjacent corners being connected by convex lines.

14. The method according to claim 11, wherein the horizontal cross-sectional contour comprises four corners, with a protrusion extending from each corner and adjacent corners being connected by straight lines.

15. The method according to claim 14, wherein the horizontal cross-sectional contour is based on a rectangle, with the long side of the contour and a long side of the foaming box having a length ratio of ≧1:2 to ≦1:5.

16. The method according to claim 14, wherein the cross-sectional contour is based on a rectangle, with the short side of the contour and a short side of the foaming box having a length ratio of ≧1:2 to ≦1:5.

17. The method according to claim 14, wherein the cross-sectional contour is based on a rectangle, the protrusions are formed by a circular arc, and for each protrusion, a distance of a center of the circular arc to a corresponding corner of the rectangle, on the one hand, and a radius of the circular arc, on the other hand, have a length ratio of ≧1:10 to ≦5.1:1.

18. The method according to claim 14, wherein the cross-sectional contour is based on a rectangle, the protrusions are formed by a circular arc, and for each protrusion, a radius of the circular arc and a side of the rectangle have a length ratio of ≧1:1 to 5 ≦1:10.

19. The method according to claim 11, wherein the slabstock foam is polyurethane foam and the reaction components comprise a polyol component and an isocyanate component.

20. A device for the discontinuous production of slabstock foam, the device comprising:
a foaming box; and
a lid adapted to be placed into the foaming box, wherein the lid comprises an opening having a horizontal cross-sectional contour comprising at least three corners, with a protrusion extending from at least one of the corners.

21. The device according to claim 20, wherein the horizontal cross-sectional contour comprises four corners, with a protrusion extending from each corner and adjacent corners being connected by concave lines.

22. The device according to claim 20, wherein the horizontal cross-sectional contour comprises four corners, with a protrusion extending from each corner and adjacent corners are connected by convex lines.

23. The device according to claim 20, wherein the horizontal cross-sectional contour comprises four corners, with a protrusion extending from each corner and adjacent corners being connected by convex lines.

24. The device according to claim 23, wherein the horizontal cross-sectional contour is based on a rectangle, with the long side of the contour and a long side of the foaming box having a length ratio of ≧1:2 to ≦1:5

25. The device according to claim 23, wherein the cross-sectional contour is based on a rectangle, with the short side of the contour and a short side of the foaming box having a length ratio of ≧1:2 to ≦1:5.

26. The device according to claim 23, wherein the cross-sectional contour is based on a rectangle, the protrusions are formed by a circular arc, and for each protrusion, a distance of a center of the circular arc to a corresponding corner of the rectangle, on the one hand, and a radius of the circular arc, on the other hand, have a length ratio of ≧1:10 to ≦1:1.

27. The device according to claim 23, wherein the cross-sectional contour is based on a rectangle, the protrusions are formed by a circular arc, and for each protrusion, a radius of the circular arc and a side of the rectangle have a length ratio of ≧1:1 to ≦1:10.
